(19) United States
(12) Patent Application Publication
(10) Pub. No.: US 2010/0001964 A1
(43) Pub. Date: Jan. 7, 2010

(54) Conductive structure and touch panel using the same

(75) Inventors: Wen-Jung Wu, Taipei County (TW); Tai-An Tsui, Taipei City (TW); Hsing-Yu Chuang, Taipei County (TW); Wei-Chih Chen, Hsinchu City (TW)

Correspondence Address: BACON & THOMAS, PLLC, 625 SLATERS LANE, FOURTH FLOOR, ALEXANDRIA, VA, 22314-1176, US

(73) Assignee: Transtouch Technology Inc., Taipei City (TW)

(21) Appl. No.: 12/318,986

(22) Filed: Jan. 14, 2009

(30) Foreign Application Priority Data
Jul. 2, 2008 (TW) 97124949

(51) Int. Cl. G06F 3/041

(52) U.S. Cl. 345/173

(57) ABSTRACT

A conductive structure including several first lateral structures, pattern structures and second lateral structures is provided. Both the first lateral structures and the pattern structures are disposed separately and around the edges of a substrate. The pattern structures are located at the inner sides of the first lateral structures. Each pattern structure has a [symbol] -shaped portion, a first lateral portion and a second lateral portion. An opening of the [symbol] -shaped portion faces at least one of the first lateral structures located at the outer side of the [symbol] -shaped portion. The first and the second lateral portions extend transversely from the two ends of the [symbol] -shaped portion toward the directions opposite to the location of the [symbol] -shaped portion, respectively. The second lateral structures are disposed alternately with the [symbol] -shaped portions and located at the inner side of at least one of the first and the second lateral portions.

This application claims the benefit of Taiwan application Serial No. 97124949, filed Jul. 2, 2008, the subject matter of which is incorporated herein by reference.

### BACKGROUND OF THE INVENTION

1. Field of the Invention

The invention relates in general to a conductive structure and a touch panel using the same, and more particularly to a conductive structure providing a linear electric field and a touch panel using the same.

2. Description of the Related Art

Along with the advance in technology, the application of touch panels has gained great popularity. The operating theory of the touch panel is as follows. When the touch panel is touched by a stylus or a user's finger, the electric field generated by the electrode pattern of the touch panel generates a signal in response to the position of touch. As the touch panel determines the position of touch according to the signal, the design of the electrode pattern of the touch panel is crucial to whether the touch panel can precisely determine the position of touch.

Generally speaking, the better the linear performance that the electric field generated by the electrode pattern shows, the more precisely the touch panel determines the position of touch. Besides, the size of the electrode pattern affects the size of the available sensing region of the touch panel as the electrode pattern and available the sensing region are located at the same surface. In other words, when the size of the electrode pattern increases, the size of the available sensing region of the touch panel decreases. Thus, despite the linear performance of the electric field can be improved by adding more rows of electrode patterns, the added rows of electrode patterns reduce the size of the available sensing region of the touch panel and increase the manufacturing cost and time correspondingly.

Accordingly, how to provide a touch panel capable of improving the linear performance of the electric field to increase the sensing precision without increasing the manufacturing cost and time has become an imminent issue.

### SUMMARY OF THE INVENTION

The invention is directed to a conductive structure and a touch panel using the same. The design of the conductive structure improves the linear performance of the electric field generated by the conductive structure, such that the touch panel is able to determine the position of touch with higher precision. Besides, the touch panel of the invention further reduces manufacturing cost and time.

According to a first aspect of the present invention, a conductive structure for being disposed on a substrate of a touch panel is provided. The conductive structure includes several first lateral structures, several pattern structures and several second lateral structures. The first lateral structures are disposed separately and around the edges of the substrate. The pattern structures are disposed separately and around the edges of the substrate. The pattern structures are located at the inner sides of the first lateral structures. Each pattern structure has a [symbol] -shaped portion, a first lateral portion and a second lateral portion. An opening of the [symbol] -shaped portion faces at least one of the first lateral structures located at the outer side of the [symbol] -shaped portion. The first lateral portion and the second lateral portion extend transversely from the two ends of the [symbol] -shaped portion toward the directions opposite to the location of the [symbol] -shaped portion, respectively. The second lateral structures are disposed alternately with the [symbol] -shaped portions of the pattern structures and located at the inner side of at least one of the first lateral portion and the second lateral portion.

According to a second aspect of the present invention, a touch panel including a substrate, a conductive layer and a conductive structure is provided. The conductive layer is disposed on the first substrate. The conductive structure is disposed on the conductive layer. The conductive structure includes several first lateral structures, several pattern structures and several second lateral structures. The first lateral structures are disposed separately and around the edges of the first substrate. The pattern structures are disposed separately and around the edges of the first substrate. The pattern structures are located at the inner sides of the first lateral structures. Each pattern structure has a [symbol] -shaped portion, a first lateral portion and a second lateral portion. An opening of the [symbol] -shaped portion faces at least one of the first lateral structures located at the outer side of the [symbol] -shaped portion. The first lateral portion and the second lateral portion extend transversely from the two ends of the [symbol] -shaped portion toward the directions opposite to the location of the [symbol] -shaped portion, respectively. The second lateral structures are disposed alternately with the [symbol] -shaped portions of the pattern structures and located at the inner side of at least one of the first lateral portion and the second lateral portion.

The invention will become apparent from the following detailed description of the preferred but non-limiting embodiments. The following description is made with reference to the accompanying drawings.

### BRIEF DESCRIPTION OF THE DRAWINGS

FIG. 1A shows a touch panel according to a preferred embodiment of the invention;

FIG. 1B shows a top view of a part of the conductive structure in FIG. 1A; and

FIG. 2 shows a touch panel according to another preferred embodiment of the invention.

### DETAILED DESCRIPTION OF THE INVENTION

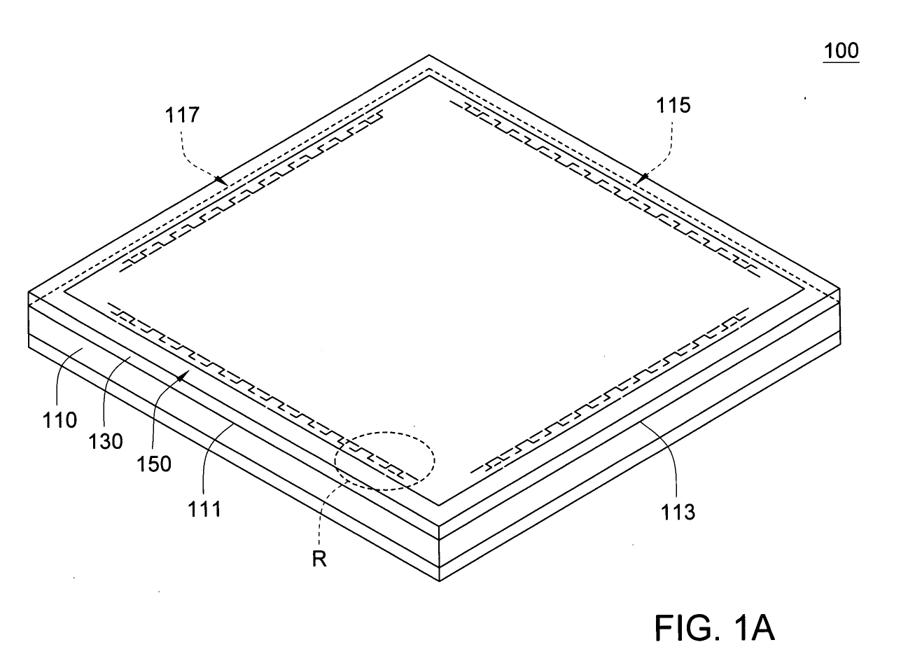

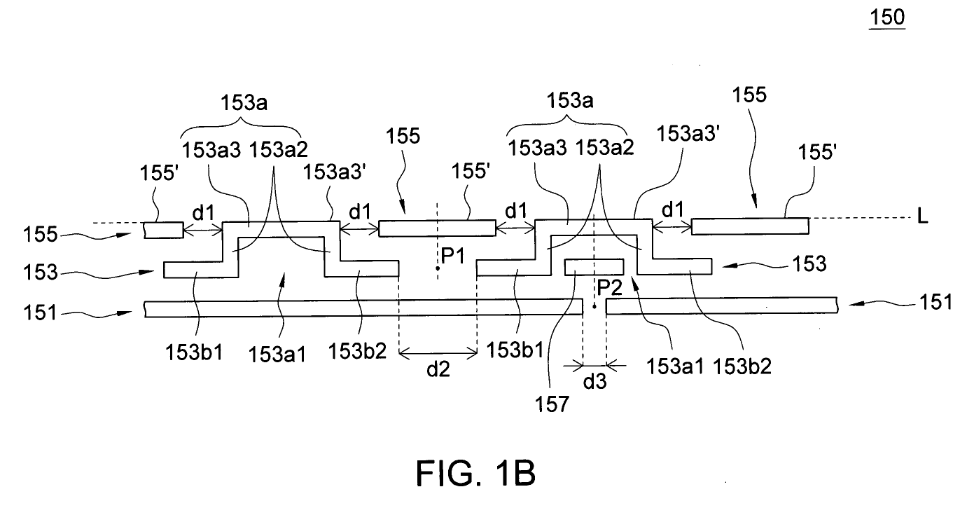

Referring to FIG. 1A, a touch panel according to a preferred embodiment of the invention is shown. The touch panel 100, such as a capacitor touch panel, includes a substrate 110, a conductive layer 130 and a conductive structure 150. The conductive layer 130 is disposed on the substrate 110. The conductive structure 150 is disposed on the conductive layer 130.

Also, referring to FIG. 1B, a top view of a part of the conductive structure in FIG. 1A is shown. Although only the conductive structure 150 disposed in the region R is taken as an example to illustrate, a person having ordinary skills in the art should understand the characteristics of the conductive structure 150 of the present embodiment of the invention by the conductive structure 150 disposed in the region R.

The conductive structure 150 includes several first lateral structures 151, several pattern structures 153 and several second lateral structures 155. The first lateral structures 151 and the pattern structures 153 are disposed separately and around the edges of the substrate 110. The pattern structures 153 are located at the inner sides of the first lateral structures 151.

Each pattern structure 153 has a [symbol] -shaped portion 153a, a first lateral portion 153b1 and a second lateral portion 153b2. An opening of 153a1 of the [symbol] -shaped portion 153a faces at least one of the first lateral structures 151 located at the outer side of the [symbol] -shaped portion 153a. The first lateral portion 153b1 and the second lateral portion 153b2 extend transversely from the two ends of the [symbol] -shaped portion 153a toward the directions opposite to the location of the [symbol] -shaped portion 153a, respectively.

The second lateral structures 155 are disposed alternately with the [symbol] -shaped portion 153a of the pattern structures 153 and located at the inner side of at least one of the first lateral portion 153b1 and the second lateral portion 153b2.

By inputting a voltage to the conductive structure 150 of the touch panel 100, the conductive structure 150 correspondingly generates an electric field at the conductive layer 130. The generated electric field is uniformly distributed as the design of the first lateral structures 151. Besides, the cooperation of the second lateral structures 155 and the pattern structures 153 makes the value of the voltage of the electric field decrease from the inputted end to the end where on voltage is applied to. Thus, the electric field of the touch panel 100 has excellent linear performance, such that the touch panel 100 is able to precisely determine the position of touch.

The touch panel 100 of the present embodiment of the invention is further elaborated below. As shown in FIG. 1A, the edges of the substrate 110 have four sides respectively designated as 111, 113, 115 and 117. The side 111 and the side 115 are substantially parallel to each other, and the side 113 and the side 117 are substantially parallel to each other. In the present embodiment of the invention, the conductive structure 150 is a biaxially symmetric structure. That is, the conductive structure 150 located at the side 111 is symmetric to the conductive structure 150 located at the side 115, and the conductive structure 150 located at the side 113 are symmetric to the conductive structure located at the side 117.

As the first lateral structures 151, the pattern structures 153 and the second lateral structures 155 are disposed around the edges of the substrate 110 having the four sides 111, 113, 115 and 117, the first lateral structures 151, the pattern structures 153 and the second lateral structures 155 are disposed at the four sides 111, 113, 115 and 117. The disposition relationship and the the shape design of the first lateral structures 151, the pattern structures 153 and the second lateral structures 155 are exemplified by those located at the side 111.

As indicated in FIG. 1A and FIG. 1B, the longer sides of the first lateral structures 151 and the second lateral structures 153 that are located at the side 111 are substantially parallel to the side 111. Each [symbol] -shaped portion 153a has a lateral portion 153a3 and two vertical portions 153a2. The two vertical portions 153a2 extend from the two ends of the lateral portion 153a3 towards the first lateral portion 153b1 and the second lateral portion 153b2 to respectively couple to one end of the first lateral portion 153b1 and one end of the second lateral portion 153b2. The longer sides of the lateral portion 153a3, the first lateral portion 153b1 and the second lateral portion 153b2 that are located at the side 111 are substantially parallel to the side 111.

Besides, as indicated in FIG. 1B, each second lateral structure 155 and the neighboring [symbol] -shaped portion 153a are spaced out an interval d1, and the length of each lateral portion 153a3 is substantially the same with that of each second lateral structure 155. The inner side 153a3′ of each lateral portion 153a3 and the inner side 155′ of each second lateral structure 155 are located along the same horizontal line L. Thus, the value of the voltage at the electric field of the touch panel 100 decreases with the same difference from the inputted end to the end where no voltage is applied to. Moreover, the first lateral portion 153b1 of each pattern structure 153 and the second lateral portion 153b2 of the neighboring pattern structure 153 are spaced out an interval d2. Preferably, the interval d2 substantially doubles the interval d1. However, the interval d2 does not have to be the double of the interval d1, and the ratio between the interval d1 and the interval d2 can be adjusted according to actual needs.

With regard to the disposition relationship between the first lateral structures 151, the pattern structures 153 and the second lateral structures 155 of the conductive structure 150, the midpoint P1 of the interval d2 is located in the extending direction of the central axis of the longer side of the second lateral structures 155. Besides, the first lateral structures 151 are mutually spaced out an interval d3. The midpoint P2 of the interval d3 is located in the extending direction of the central axis of the longer side of the lateral portion 153b2. Besides, as indicated in FIG. 1B, the conductive structure 150 of the present embodiment of the invention further includes a third lateral structure 157 which is, for example, located at the opening 153a1.

The design of the conductive structure 150 located at the side 111 is disclosed above. The design of the conductive structure 150 located at the sides 113, 115 and 117 is similar to that of the conductive structure 150 located at the side 111 and is not repeated here. Preferably, at least two first conductive structures 151 are located at each of the sides 111, 113, 115 and 117.

In the present embodiment of the invention, the intervals d1 located at the sides 111 and 115 is the same with the intervals d1 located at the sides 113 and 117, and the intervals d2 located at the sides 111 and 115 is the same with the intervals d2 located at the sides 113 and 117. However, the invention is not limited to the above exemplification. That is, the intervals d1 located at the sides 111 and 115 can differ from the intervals d1 located at the sides 113 and 117, and the intervals d2 located at the sides 111 and 115 can differ from the intervals d2 located at the sides 113 and 117.

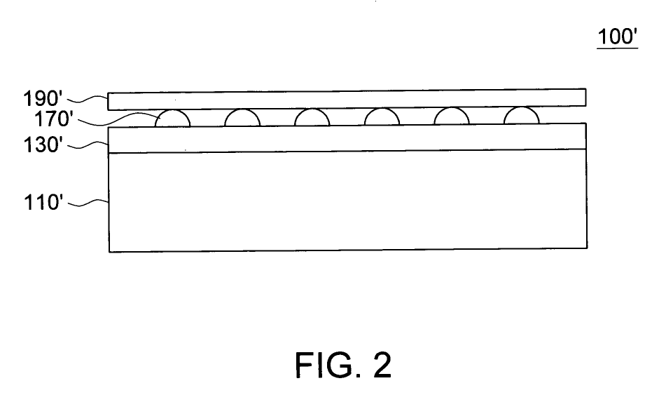

Referring to FIG. 2, a touch panel according to another preferred embodiment of the invention is shown. The touch panel 100′ in FIG. 2 is, for example, a five line resistance touch panel. The touch panel 100′ includes a substrate 110′, a conductive layer 130′, the conductive structure 150 (not illustrated in FIG. 2) as indicated in FIG. 1A, several dot spacers 170′ and a substrate 190′. The conductive structure 150 is disposed on the conductive layer 130′ and around the edges of the conductive layer 130′. The substrate 190′ disposed with respect to the substrate 110′ is, for example, a flexible conductive layer. The dot spacers 170′ are disposed between the conductive layer 130′ and the substrate 190′ for electrically isolating the conductive layer 130′ and flexible conductive layer 190′ when a user does not touch the touch panel 100′. As the disposition of the conductive structure 150, the electric field of the touch panel 100′ has excellent linear performance, such that the touch panel 100′ is able to precisely determine the position of touch. However, the structures and disposition of the touch panels 100 and 100′ are used as examples of the application of the conductive structure 150, and the present invention is not limited herein.

According to the conductive structure and the touch panel using the same disclosed in the above embodiments of the invention, the linear performance of the generated electric field is improved as a result of the design of the conductive structure, such that the touch panel of the present embodiment of the invention is able to precisely determine the position of touch. In contrast, the overall size of the conductive structure of the present embodiment of the invention is smaller than the overall size of the multi-row conductive structure. When the conductive structure of the present embodiment of the invention and the multi-row conductive structure are respectively disposed on the same touch panel, the touch panel disposed with the conductive structure of the present embodiment of the invention has the larger available sensing region. Thus, the touch panel of the present embodiment of the invention is convenient for the user to operate and meet the user's size requirement of the available sensing region. Moreover, the overall size of the conductive structure of the present embodiment of the invention is smaller to correspondingly reduce manufacturing cost and time.

While the invention has been described by way of example and in terms of a preferred embodiment, it is to be understood that the invention is 10 not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A conductive structure for being disposed on a substrate of a touch panel, wherein the conductive structure comprises:
a plurality of first lateral structures disposed separately and around the edges of the substrate;
a plurality of pattern structures disposed separately and around the edges of the substrate, wherein the pattern structures are located at the inner sides of the first lateral structures, each pattern structure has a [symbol] -shaped portion, a first lateral portion and a second lateral portion, an opening of the [symbol] -shaped portion faces at least one of the first lateral structures located at the outer side of the [symbol] -shaped portion, and the first lateral portion and the second lateral portion extend transversely from the two ends of the [symbol] -shaped portion toward the directions opposite to the location of the [symbol] -shaped portion, respectively; and
a plurality of second lateral structures disposed alternately with the [symbol] -shaped portions of the pattern structures and located at the inner side of at least one of the first lateral portion and the second lateral portion.

2. The conductive structure according to claim 1, wherein the conductive structure is a biaxially symmetric structure.

3. The conductive structure according to claim 1, wherein each second lateral structure and the neighboring [symbol] -shaped portion are spaced out a first interval, and the first lateral portion of each pattern structure and the second lateral portion of the neighboring pattern structure are spaced out a second interval.

4. The conductive structure according to claim 3, wherein the midpoint of the second interval is located in the extending direction of the central axis of the longer side of the second lateral structure.

5. The conductive structure according to claim 3, wherein the second interval substantially doubles the first interval.

6. The conductive structure according to claim 1, wherein each [symbol] -shaped portion has a lateral portion and two vertical portions extending from the two ends of the lateral portion towards the first lateral portion and the second lateral portion to respectively couple to one end of the first lateral portion and one end of the second lateral portion, and the length of each lateral portion is substantially the same with the length of each second lateral structure.

7. The conductive structure according to claim 6, wherein the first lateral structures are mutually spaced out an interval, and the midpoint of the interval is located in the extending direction of the central axis of the longer side of the lateral portion.

8. The conductive structure according to claim 6, wherein the inner side of each lateral portion and the inner side of each second lateral structure are located along the same horizontal line.

9. The conductive structure according to claim 1, further comprising:
at least one third lateral structure located at one of the openings.

10. The conductive structure according to claim 1, wherein the edges of the substrate have four sides substantially parallel to each other in pairs, and the longer sides of the first lateral structures and the second lateral structures that are located at one of the sides are substantially parallel to the one of the sides;
wherein, each [symbol] -shaped portion has a lateral portion and two vertical portions extending from the two ends of the lateral portion towards the first lateral portion and the second lateral portion to respectively couple to one end of the first lateral portion and one end of the second lateral portion, and the longer sides of the lateral portions, the first lateral portions and the second lateral portions that are located at the one of the sides are substantially parallel to the one of the sides.

11. The conductive structure according to claim 1, wherein the edges of the substrate have four sides, and at least two first conductive structures are located at one of the sides.

12. A touch panel, comprising:
a first substrate;
a conductive layer disposed on the first substrate; and
a conductive structure disposed on the conductive layer, wherein the conductive structure comprises:
a plurality of first lateral structures disposed separately and around the edges of the first substrate;
a plurality of pattern structures disposed separately and around the edges of the first substrate, wherein the pattern structures are located at the inner sides of the first lateral structures, each pattern structure has a [symbol] -shaped portion, a first lateral portion and a second lateral portion, an opening of the [symbol] -shaped portion faces at least one of the first lateral structures located at the outer side of the [symbol] -shaped portion, and the first lateral portion and the second lateral portion extend transversely from the two ends of the [symbol] -shaped portion toward the directions opposite to the location of the [symbol] -shaped portion, respectively; and
a plurality of second lateral structures disposed alternately with the [symbol] -shaped portions of the pattern structures and located at the inner side of at least one of the first lateral portion and the second lateral portion.

13. The touch panel according to claim 12, wherein the conductive structure is a biaxially symmetric structure.

14. The touch panel according to claim 12, wherein each second lateral structure and the neighboring [symbol] -shaped portion are spaced out a first interval, the first lateral portion of each pattern structure and the second lateral portion of the neighboring pattern structure are spaced out a second interval.

15. The touch panel according to claim 14, wherein the midpoint of the second interval is located in the extending direction of the central axis of the longer side of the second lateral structure.

16. The touch panel according to claim 14, wherein the second interval substantially doubles the first interval.

17. The touch panel according to claim 12, wherein each [symbol] -shaped portion has a lateral portion and two vertical portions extending from the two ends of the lateral portion towards the first lateral portion and the second lateral portion respectively couple to one end of the first lateral portion and one end of the second lateral portion, and the length of each lateral portion is substantially the same with the length of each second lateral structure.

18. The touch panel according to claim 17, wherein the first lateral structures are mutually spaced out an interval, and the midpoint of the interval is located in the extending direction of the central axis of the longer side of the lateral portion.

19. The touch panel according to claim 17, wherein the inner side of each lateral portion and the inner side of each second lateral structure are located along the same horizontal line.

20. The touch panel according to claim 12, wherein the conductive structure further comprises:
at least one third lateral structure located at one of the openings.

21. The touch panel according to claim 12, wherein the edges of the first substrate have four sides substantially parallel to each other in pairs, and the longer sides of the first lateral structures and the second lateral structures that are located at one of the sides are substantially parallel to the one of the sides;
wherein, each [symbol] -shaped portion has a lateral portion and two vertical portions extending from the two ends of the lateral portion towards the first lateral portion and the second lateral portion to respectively couple to one end of the first lateral portion and one end of the second lateral portion, and the longer sides of the lateral portions, the first lateral portions and the second lateral portions that are located at the one of the sides are substantially parallel to the one of the sides.

22. The touch panel according to claim 12, wherein the edges of the first substrate have four sides, and at least two first conductive structures are located at one of the sides.

23. The touch panel according to claim 12, further comprising:
a second substrate disposed with respect to the first substrate; and
a plurality of dot spacers disposed between the conductive layer and the second substrate.
